(19) United States
(12) Patent Application Publication
(10) Pub. No.: US 2007/0051076 A1
(43) Pub. Date: Mar. 8, 2007

(54) Stirrup leather buckle

(76) Inventor: Harry William Dabbs, West Midlands (GB)

Correspondence Address: SMITH-HILL AND BEDELL, P.C., 16100 NW CORNELL ROAD, SUITE 220, BEAVERTON, OR, 97006, US

(21) Appl. No.: 10/553,140

(22) PCT Filed: Apr. 16, 2004
(86) PCT No.: PCT/GB04/01658

§ 371 Date: Nov. 30, 2005

(30) Foreign Application Priority Data
Apr. 16, 2003 (GB) 0308773.1

(51) Int. Cl. B68C 1/16

(52) U.S. Cl. 54/46.1

(57) ABSTRACT

A stirrup leather 12 is installed over a stirrup bar 14 by means of a buckle 24a. The buckle frame has a curvature which forms a recess in which the stirrup bar 14 is received, which allows the buckle frame to sit closer to the saddle 10 than is possible with a planar buckle. This results in an arrangement which is more comfortable under the thigh of the rider.

The present invention relates to equestrian stirrups and in particular, but not exclusively, to aspects of attaching stirrups to saddles.

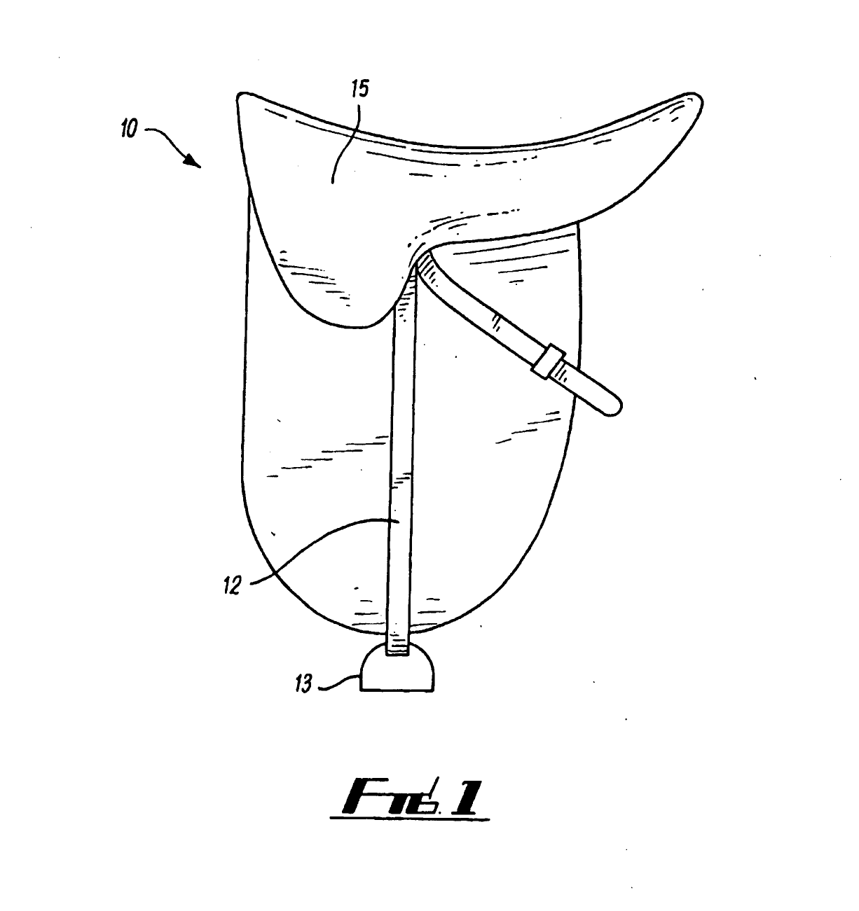

A conventional arrangement for equestrian stirrups is simply illustrated in FIG. 1. A saddle 10 uses stirrup leathers 12 which include a buckle (not shown) to be adjustable in length. The buckle is used to form the stirrup leather 12 into a loop which carries the stirrup 13 at its lower end, and is attached to the saddle at its upper end, by placement over a stirrup bar. The buckle is located in the vicinity of the stirrup bar, covered by a skirt 15 of leather. It is found that this arrangement can be uncomfortable for some riders, because the stirrup bar and buckle form a prominent bump under the skirt 15, in the vicinity of the rider's thigh.

The present invention provides a stirrup buckle for connecting the ends of a stirrup leather to secure the stirrup leather on a stirrup bar, the buckle comprising:

a frame attached, in use, to the stirrup leather at one end region thereof;

a tongue pivotally attached to the frame for penetrating the strap at the other end region thereof and thereafter to bear on the frame to retain the said other end;

and wherein the frame is shaped to form a recess which at least partially receives the stirrup bar, in use.

The frame is preferably curved to define the recess. The frame preferably defines a concavity when viewed transverse to the length of the strap and in the plain of the strap.

The frame may be generally rectangular in form, comprising side arms extending generally parallel to the strap, and connecting cross bars, at least the side arms being curved to define the recess.

The frame may include a pivot bar, the tongue having an eye through which the pivot bar extends to form the pivotal attachment, the tongue being sufficiently long to position the pivot bar clear of the stirrup bar, during use. The pivot bar is preferably formed to define a pivot axis which is offset in the direction of the recess, relative to the centre line of the frame. The pivot axis is preferably offset sufficiently that substantially no part of the eye can project beyond the frame, in the direction away from the recess.

In a further aspect, the invention provides a stirrup buckle for connecting the ends of a stirrup leather to secure the stirrup leather on a stirrup bar, the buckle comprising:

a frame attached, in use, to the stirrup leather at one end region thereof;

a tongue pivotally attached to the frame for penetrating the strap at the other end region thereof and thereafter to bear on the frame to retain the said other end;

and wherein the tongue is sufficiently long that the position of the pivotal attachment of the tongue is clear of the stirrup bar, during use.

The frame is preferably shaped to form a recess which at least partially receives the stirrup bar, in use.

The frame may include a pivot bar, the tongue having an eye through which the pivot bar extends to form the pivotal attachment. The pivot bar is preferably formed to define a pivot axis which is offset in the direction of the recess, relative to the centre line of the frame. The pivot axis is preferably offset sufficiently that substantially no part of the eye can project beyond the frame, in the direction away from the recess.

The frame is preferably curved to define the recess. The frame preferably defines a concavity when viewed transverse to the length of the strap and in the plain of the strap.

The frame may be generally rectangular in form, comprising side arms extending generally parallel to the strap, and connecting cross bars, at least the side arms being curved to define the recess.

The invention also provides a stirrup leather which includes a stirrup buckle as defined above.

The invention also provides a saddle arrangement, the saddle having at least one stirrup bar, and the arrangement including at least one stirrup leather as defined in the previous paragraph, for securing to the stirrup bar.

An embodiment of the present invention will now be described in more detail, by way of example only, and with reference to the accompanying drawings, in which:—

FIG. 1 is a simple side elevation of a conventional saddle;

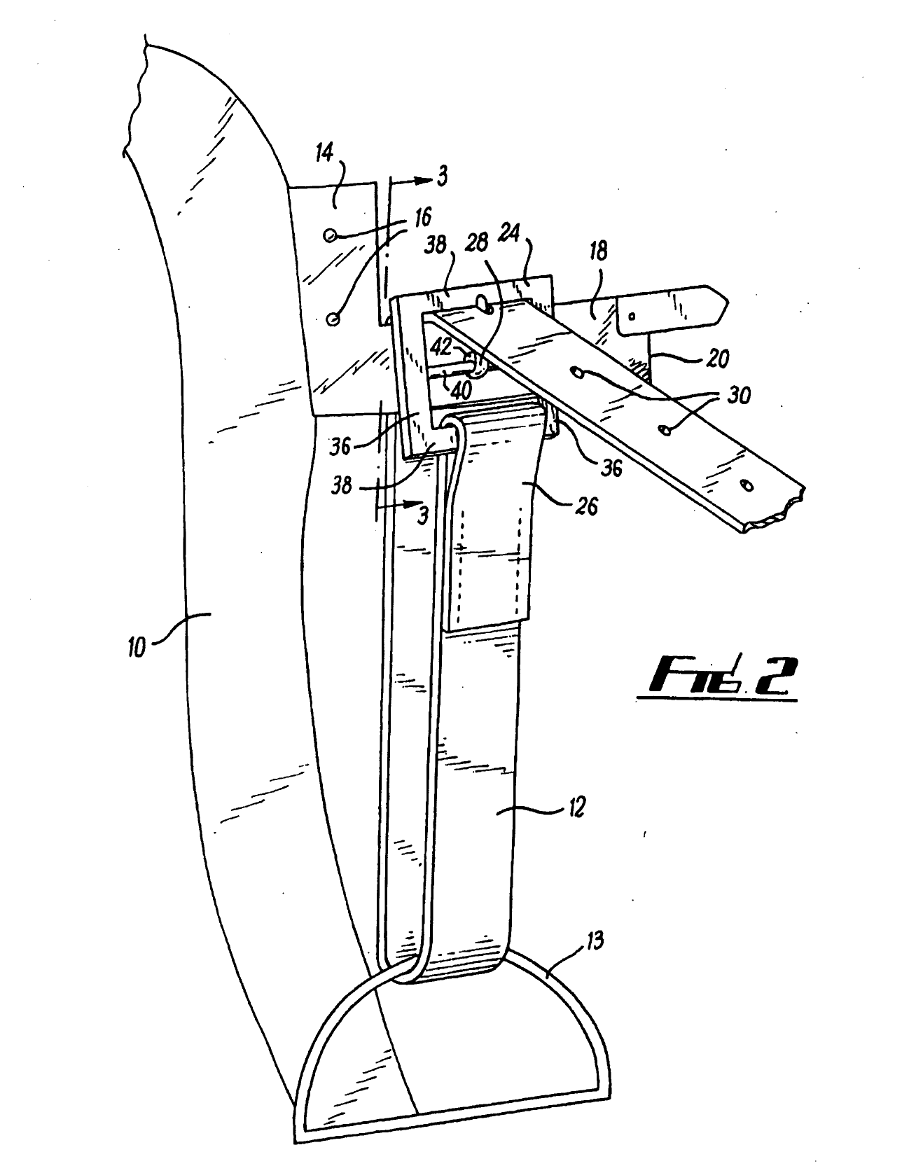

FIG. 2 is a perspective view of part of the saddle of FIG. 1, on an enlarged scale;

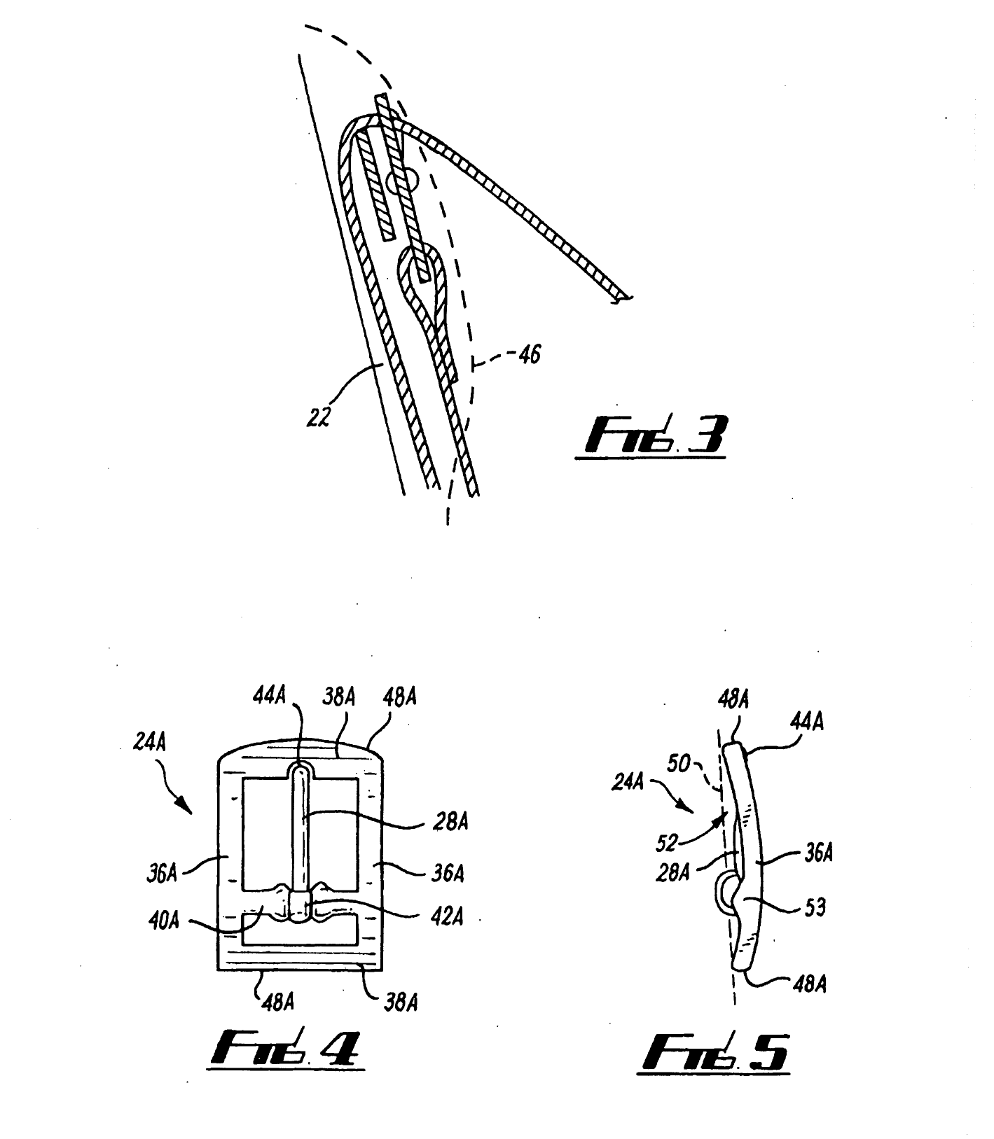

FIG. 3 is a section showing the arrangement buckle of FIG. 2, viewed at the line 3-3 of FIG. 2;

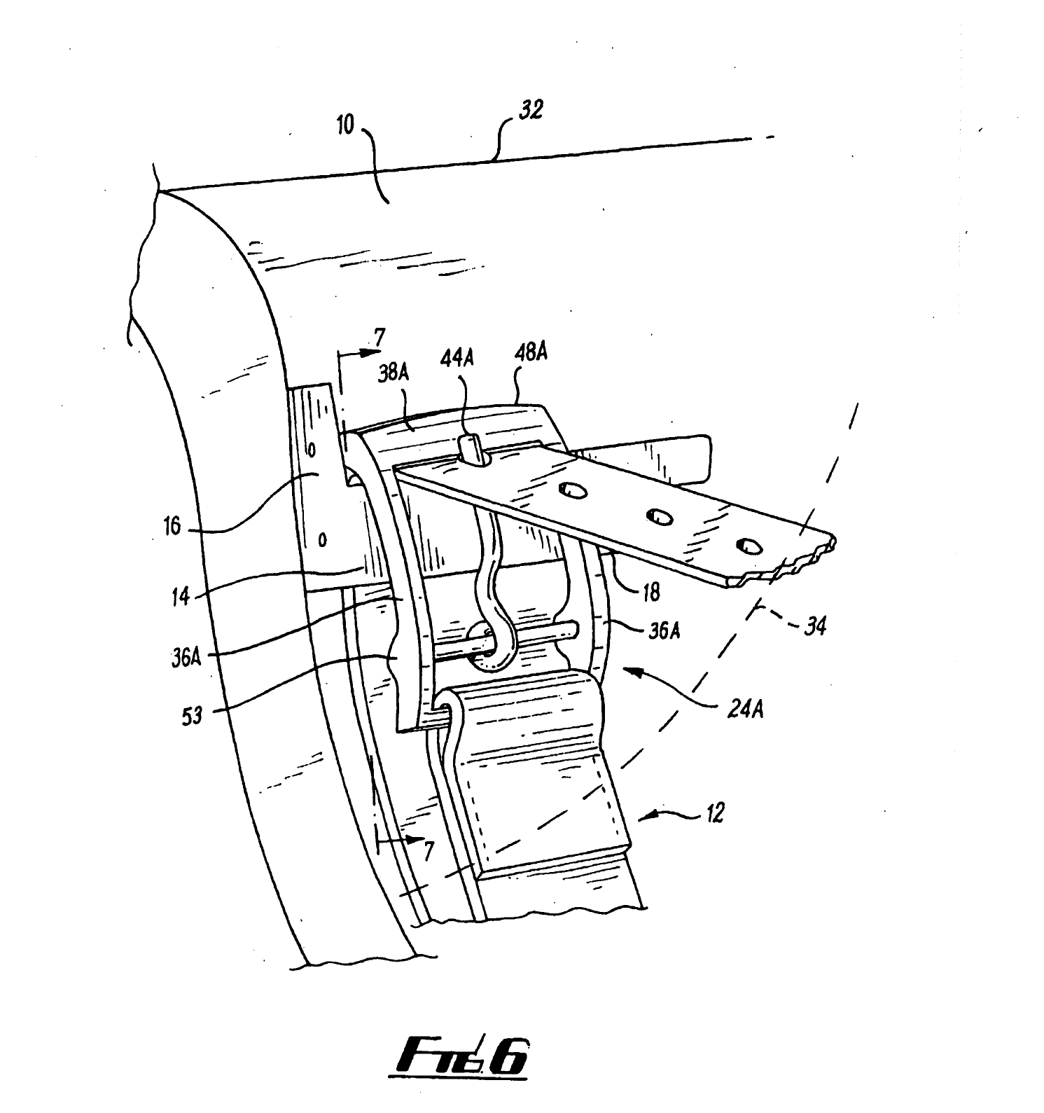

FIGS. 4 and 5 are plan and side views of a buckle according to the present invention;

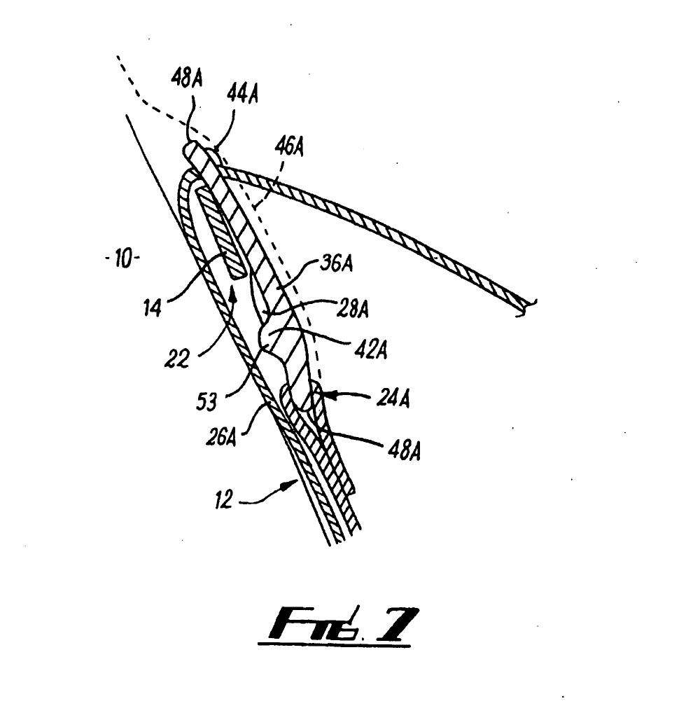

FIG. 6 is a perspective view corresponding with FIG. 2, showing the buckle of FIGS. 4 and 5 in use; and

FIG. 7 is a section view along the line 7-7 of FIG. 6.

FIG. 2 shows part of a saddle 10 to which a stirrup leather 12 is attached.

The saddle 10 carries a stirrup bar 14, attached to the saddle 10 at 16. The bar 14 has a shank 18 which extends back from the attachment 16 to a free end 20. The shank 18 is shaped to define a gap 22 between the shank 18 and the saddle 10, as can be seen in FIG. 3. The gap 22 is for accommodating the stirrup leather 12.

The leather 12 carries a buckle 24. This is attached at 26 to one end of the stirrup leather 12. The leather 12 then extends down from the buckle 24 to the stirrup 13. The stirrup 13 is threaded onto the leather 12. The free end of the leather 12 then passes back up to the bar 14, through the gap 22, over the bar 14 and through the buckle 24. The free end of the leather 12 is retained by the buckle tongue 28, which penetrates a chosen hole 30 preformed in the leather 12, so that the overall length of the leather 12 can be adjusted, thus setting the height of the stirrup 13 relative to the saddle 10. The spare end of the leather 12 is tucked away, for convenience and safety, in a loop provided elsewhere on the saddle and not visible in FIG. 2.

The skirt 15 is not shown in FIG. 2, for clarity.

The buckle 24 has a generally rectangular frame formed by parallel side arms 36, which are straight (as can be seen from FIG. 2) and extend parallel with the length of the leather 12. The ends of the arms 36 are connected by connecting bars 38, which are also straight. Consequently, the arms 36 and bars 38 define a generally planar frame.

A pivot bar 40 extends across the frame and within the plane of the frame. The tongue 28 has an eye 42 at one end (FIG. 2), the eye 42 being located around the pivot bar 40. The length of the tongue 28 is sufficient to extend from the bar 40 to bear on the upper of the bars 38, as can be seen in FIG. 2, in order to retain the leather.

It can thus be seen, particularly from FIG. 3, that when the stirrup leather 12 is in position on the stirrup bar 14, the buckle 24 sits against the bar 14. In particular, the eye 42 bears against the bar 14, so that the plane of the buckle frame is further spaced from the saddle 10, beyond the bar 14.

Thus, the envelope 46 of the arrangement projects significantly from the saddle 10 in the region of the bar 14 and is found to provide a source of discomfort to riders, whose thighs will be against this region of the saddle 10.

The remaining drawings relate to a buckle of the present invention. Corresponding features of items other than the buckle are given the same reference numerals as in FIGS. 1, 2 and 3. Some features of the buckle are given the same reference numeral as the buckle of FIGS. 1, 2 and 3, with the suffix “A”, where there is sufficient correspondence between those features to assist in the clarity of the description.

Turning first to FIGS. 4 and 5, the buckle 24A, in accordance with the invention, has a frame formed of side arms 36A and connecting bars 38A and has a pivot bar 40A to provide a pivot for a tongue 28A. Unlike the frame of the buckle 24, the frame of the buckle 24A is not planar. The frame is curved as can be seen most clearly in FIG. 5. This curvature arises because the side arms 36A are curved when viewed transverse to the length of the strap and in the plane of the strap. Consideration of the straight broken line 50 in FIG. 5 indicates that this curvature results in a concavity which forms a shallow recess 52, the significance of which will become apparent.

It can be seen from FIGS. 4 and 5 that the tongue 28A is longer than the tongue 28 of the buckle of FIGS. 1 to 3. This extra length is accommodated by spacing the pivot bar 40A further away from the upper connecting bar 38A against which the tongue 28A bears.

It can also be seen from FIG. 5 that the pivot bar 40A is supported by ears 53 on the side arms 36A, to be offset relative to the centre line of the side arms 36A, and in the direction of the recess 52. Thus, although the tongue 28A is attached to the bar 40A by means of an eye 42A through which the bar 40A extends, this arrangement is offset towards the recess 52, so that no part of the eye projects beyond the side arms 36A, in the direction away from the recess. In addition, this brings the length of the tongue 28A within the frame, so that only the extreme end 44A projects beyond the side arms 36A, in order to engage one of the connecting bars 38A.

FIGS. 6 and 7 show the buckle of FIGS. 4 and 5, in use. The stirrup leather 12 is installed in generally the same manner as has been described in relation to FIGS. 1, 2 and 3, but by means of the buckle 24A. The resulting arrangement is, however, significantly different, as can be seen from FIGS. 6 and 7. Looking particularly at FIG. 7, it can be seen that the stirrup bar 14 is received, at least partly, within the recess 52 formed by the shape of the buckle frame. It can also be seen that the extra length of the tongue 28A positions the pivot bar 40A beyond the stirrup bar 14 so that the eye 42A can drop below the outer plane of the bar 14. This is further facilitated by the ears 53 and results in no part of the eye 42A projecting beyond the side arms 36A. In addition, the curvature of the side arms 36A allows the connecting bars at 38A to be closer to the saddle 10 than is possible in the arrangement of FIGS. 1 and 2, and arises because of the curvature of the side arms 36A. In addition, the curvature of the side arms 36A results in a less uncomfortable edge at 48A. Furthermore, the offset of the pivot bar 40A results in the tongue 28A projecting not at all, or only very slightly beyond the buckle 24A. The result is that the envelope 46A of the arrangement is shallower (i.e. projects less from the saddle 10) and also is smoother (with fewer discontinuities, edges etc). This results in an arrangement which is more comfortable under the thigh of the rider.

Many variations and modifications could be made to the arrangements described above, with departing from the scope of the invention. For example, the bars 38A can be curved to further reduce and smooth the envelope 46A.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A stirrup buckle for connecting the ends of a stirrup leather to secure the stirrup leather on a stirrup bar, the buckle comprising:
a frame attached, in use, to the stirrup leather at one end region thereof;
a tongue pivotally attached to the frame for penetrating the strap at the other end region thereof and thereafter to bear on the frame to retain the said other end;
and wherein the frame is shaped to form a recess which at least partially receives the stirrup bar, in use.

2. A stirrup buckle according to claim 1, wherein the frame is curved to define the recess.

3. A stirrup buckle according to claim 2, wherein the frame defines a concavity when viewed transverse to the length of the strap and in the plain of the strap.

4. A stirrup buckle according to claim 2, wherein the frame is generally rectangular in form, comprising side arms extending generally parallel to the strap, and connecting cross bars, at least the side arms being curved to define the recess.

5. A stirrup buckle according to claim 1, wherein the frame includes a pivot bar, the tongue having an eye through which the pivot bar extends to form the pivotal attachment, the tongue being sufficiently long to position the pivot bar clear of the stirrup bar, during use.

6. A stirrup buckle according to claim 5, wherein the pivot bar is formed to define a pivot axis which is offset in the direction of the recess, relative to the centre line of the frame.

7. A stirrup buckle according to claim 6, wherein the pivot axis is offset sufficiently that substantially no part of the eye can project beyond the frame, in the direction away from the recess.

8. A stirrup buckle for connecting the ends of a stirrup leather to secure the stirrup leather on a stirrup bar, the buckle comprising:
a frame attached, in use, to the stirrup leather at one end region thereof;
a tongue pivotally attached to the frame for penetrating the strap at the other end region thereof and thereafter to bear on the frame to retain the said other end;
and wherein the tongue is sufficiently long that the position of the pivotal attachment of the tongue is clear of the stirrup bar, during use.

9. A stirrup buckle according to claim 8, wherein the frame is shaped to form a recess which at least partially receives the stirrup bar, in use.

10. A stirrup buckle according to claim 9, wherein the frame includes a pivot bar, the tongue having an eye through which the pivot bar extends to form the pivotal attachment.

11. A stirrup buckle according to claim 10, wherein the pivot bar is formed to define a pivot axis which is offset in the direction of the recess, relative to the centre line of the frame.

12. A stirrup buckle according to claim 11, wherein the pivot axis is offset sufficiently that substantially no part of the eye can project beyond the frame, in the direction away from the recess.

13. A stirrup buckle according to any claim 9, wherein the frame is curved to define the recess.

14. A stirrup buckle according to claim 13, wherein the frame defines a concavity when viewed transverse to the length of the strap and in the plain of the strap.

15. A stirrup buckle according to claim 9, wherein the frame is generally rectangular in form, comprising side arms extending generally parallel to the strap, and connecting cross bars, at least the side arms being curved to define the recess.

16. A stirrup leather which includes a stirrup buckle in accordance with claim 8.

17. A saddle arrangement, the saddle having at least one stirrup bar, and the arrangement including at least one stirrup leather as defined claim 16.

18-21. (canceled)

22. A stirrup leather which includes a stirrup buckle in accordance with claim 1.

23. A saddle arrangement, the saddle having at least one stirrup bar, and the arrangement including at least one stirrup leather as defined in claim 22.
